(19) United States
(12) Patent Application Publication
(10) Pub. No.: US 2010/0135336 A1
(43) Pub. Date: Jun. 3, 2010

(54) METHOD, APPARATUS, AND SYSTEM FOR SYNCHRONIZING TIME

(75) Inventors: Jian Zhou, Shenzhen (CN); Hui Huang, Shenzhen (CN); Tong Luo, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/629,260

(22) Filed: Dec. 2, 2009

(30) Foreign Application Priority Data
Dec. 2, 2008 (CN) 200810227880.0

(51) Int. Cl. H04J 3/06; G06F 1/12; H04L 7/00

(52) U.S. Cl. 370/503; 375/354; 713/400

(57) ABSTRACT

The present invention discloses a method, an apparatus, and a system for synchronizing time, and relates to communication technologies. The method includes: receiving a time synchronization signal which includes a One Pulse Per Second (1PPS) and an absolute time data; and sending the time synchronization signals to the client through a wired medium to synchronize time. The apparatus includes a receiving module and a sending module. The system includes a time synchronization apparatus and a client. Time synchronization is implemented through an existing wired medium between base stations to accomplish μs-level time synchronization between indoor base stations without extra cabling.

### CROSS-REFERENCE TO RELATED APPLICATION

This application claims priority to Chinese Patent Application No. 200810227880.0, filed on Dec. 02, 2008, which is hereby incorporated by reference in its entirety.

### FIELD OF THE INVENTION

The present invention relates to communication technologies, and in particular, to a method, an apparatus, and a system for synchronizing time.

### BACKGROUND

The continuous networking application of the wireless communication system employs a Time Division Multiplexing (TDM) technology which requires precise time synchronization between base stations. For example, Code Division Multiple Access (CDMA) 2000, Time Division-Synchronous Code Division Multiple Access (TD-SCDMA), and Worldwide Interoperability for Microwave Access (WiMAX) require the synchronization precision to be 10 μs or better. For the Wideband Code Division Multiple Access (WCDMA), when the WCDMA provides certain Value-Added Systems (VASs) such as basestation-based high-precision positioning service, the time synchronization between base stations needs to be as precise as 1 μs.

The networks mentioned above are full-IP networks, which involve no E1/T1 connection. Therefore, the basestation is unable to recover timing synchronization from the line. In the prior art, the time synchronization between base stations is implemented through a Global Positioning System (GPS) or a GLObal NAvigation Satellite System (GLONASS) receiver, which receives the One Pulse Per Second (1PPS) and absolute time information from the GPS satellite as the time synchronization reference of the system. The 1PPS serves as a reference frequency, the control voltage is generated through a software algorithm together with a hardware Phased Locked Loop (PLL) to control the oscillation frequency of the constant-temperature crystal oscillator and generate a reference clock of the basestation, thus implementing time synchronization between base stations and providing timing as precise as 1 μs for users.

In the process of developing the present invention, the inventor finds at least the following defects in the prior art:

In the application of an indoor basestation, some indoor GPS signals are weak, and the GPS signals are hardly receivable; and in the attempt of connecting the antenna of a GPS receiver to the outdoor area through cables, the construction is difficult.

### SUMMARY

In order to implement μs-level time synchronization between indoor base stations where the signals are weak, the embodiments of the present invention provide a method, an apparatus, and a system for synchronizing time. The technical solution is as follows:

A time synchronization method includes:

receiving a time synchronization signal which includes a 1PPS and an absolute time data;

sending the time synchronization signal to a client through a wired medium for synchronizing time.

A time synchronization apparatus includes:

a receiving module, adapted to receive a time synchronization signal which includes a 1PPS and an absolute time data; and
a sending module, adapted to send the time synchronization signal to a client through a wired medium for synchronizing time.

A client includes:

a receiving module, adapted to receive a time synchronization signal; and
a synchronizing module, adapted to synchronize time according to the time synchronization signal.

A time synchronization system is disclosed herein. The time synchronization system includes a time synchronization apparatus and a client.

The time synchronization apparatus is adapted to receive time synchronization signal which includes a 1PPS and an absolute time data, and send the time synchronization signal to the client through a wired medium.

The client is adapted to receive the time synchronization signal from the time synchronization apparatus, and synchronize time according to the time synchronization signal.

The technical solution under the present invention brings the following benefits:

Time synchronization signals are transmitted through the existing wired medium between base stations to synchronize the time between base stations and accomplish the μs-level time synchronization between indoor base stations without extra cabling.

### BRIEF DESCRIPTION OF THE DRAWINGS

FIG. 1 is a schematic diagram of an embodiment of a time synchronization method;

FIG. 2 is a schematic diagram of another embodiment of a time synchronization method;

FIG. 3 is a schematic structure of an embodiment of a time synchronization frame;

FIG. 4 is a schematic structure of an embodiment of a CLK server;

FIG. 5A-5B is a schematic structure of an embodiment of a CLK client;

FIG. 6 is a schematic structure of an embodiment of a time synchronization system;

FIG. 7 is a schematic structure of an embodiment of a time synchronization apparatus; and

FIG. 8 is a schematic structure of an embodiment of a client.

### DETAILED DESCRIPTION

In order to make the technical solution, objectives and merits of the present invention clearer, the following describes the embodiments of the present invention in more detail with reference to accompanying drawings.

### EMBODIMENT 1

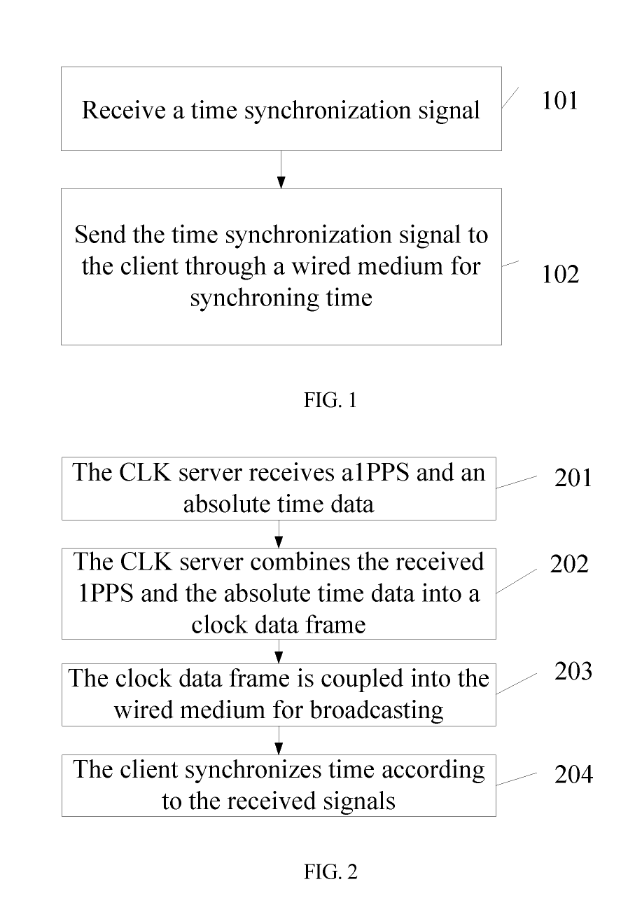

As shown in FIG. 1, a time synchronization method provided in this embodiment includes the following steps:

S101: Receiving a time synchronization signal which includes a 1PPS and an absolute time data.

S102: Sending the time synchronization signal to a client through a wired medium for synchronizing time.

Step 102 may include:

S102A: Coupling the time synchronization signal into the wired medium.

S102B: Broadcasting the time synchronization signal in the wired medium.

S102C: Synchronizing time, by the client, according to the received time synchronization signal.

Step 102A may include:

combining the 1PPS and the absolute time data into a clock data frame; and

spreading the clock data frame through spreading codes, filtering the clock data frame (for example, through shaping filtering or interpolation filtering), modulating the clock data frame (for example, through 2-base Differential Phase Shift Keying (2DPSK)), and then converting the clock data frame into an analog signal, for example, through digital up-converting or digital-analog conversion; and further, performing low-pass filtering and driving amplification for the analog signal, and coupling the analog signal into the wired medium.

Step 102C includes:

receiving, by the client, the time synchronization signal;

obtaining, by the client, a synchronization identifier through applying to the time synchronization signal a converse of the foregoing process, for example, the bandpass filtering, Automatic Gain Control (AGC), Analog-to-Digital Converter (ADC), digital down-converting, spreading code capturing and tracking, and carrier synchronization and demodulation;

processing, by the client, the synchronization identifier to obtain a synchronization pulse of the 1PPS and the absolute time information; and

synchronizing, by the client, the time according to the 1PPS and the absolute time information.

In this embodiment, the base stations are connected through wired medium, the received time synchronization signal are coupled into the wired medium for broadcasting, and the client obtains the time synchronization signal after receiving the broadcast signal. In this way, the time is synchronized between the base stations, and the μs-level time synchronization is accomplished between indoor base stations without extra cabling. Moreover, the time synchronization signal is spread through spreading codes to suppress the channel interference and attenuation of the wired network (especially complicated power cables) and ensure the synchronization precision.

### EMBODIMENT 2

In this embodiment, time needs to be synchronized between a basestation with a GPS receiver and one or more base stations without a GPS receiver. The basestation with a GPS receiver may serve as a time synchronization server, briefly known as “CLK server”, and the other base stations without a GPS receiver serve as time synchronization clients, briefly known as “CLK clients”. Supposing that the CLK server can receive GPS signals, a CLK server can support time synchronization in a wider area by adding more functional units. The CLK server is connected with the CLK clients through wired medium. The wired medium includes: low-voltage power cable, coax cable (cable television), twisted pair (telephone line), and so on.

As shown in FIG. 2, a time synchronization method provided in this embodiment includes the following steps:

S201: The CLK server receives a 1PPS and an absolute time data.

The 1PPS and the absolute time data may be received through a GPS receiver.

The 1PPS and the absolute time data are collectively called “time synchronization signals”.

S202: The CLK server combines the received 1PPS and the absolute time data into a clock data frame.

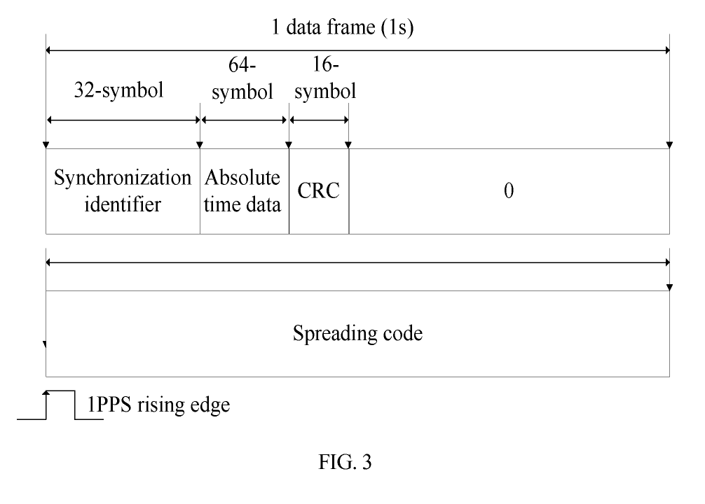

In order to ensure the jitter precision between the 1PPS recovered by the CLK client and the 1PPS received by the CLK server from the GPS, the schematic structure of a clock data frame shown in FIG. 3 applies. The spreading codes may be an M sequence with a length of 1024, and the selected chip clock may be 1.2288 MHz. FIG. 3 shows only one of the frame structures available for selection. In practice, other spreading codes may be selected as required.

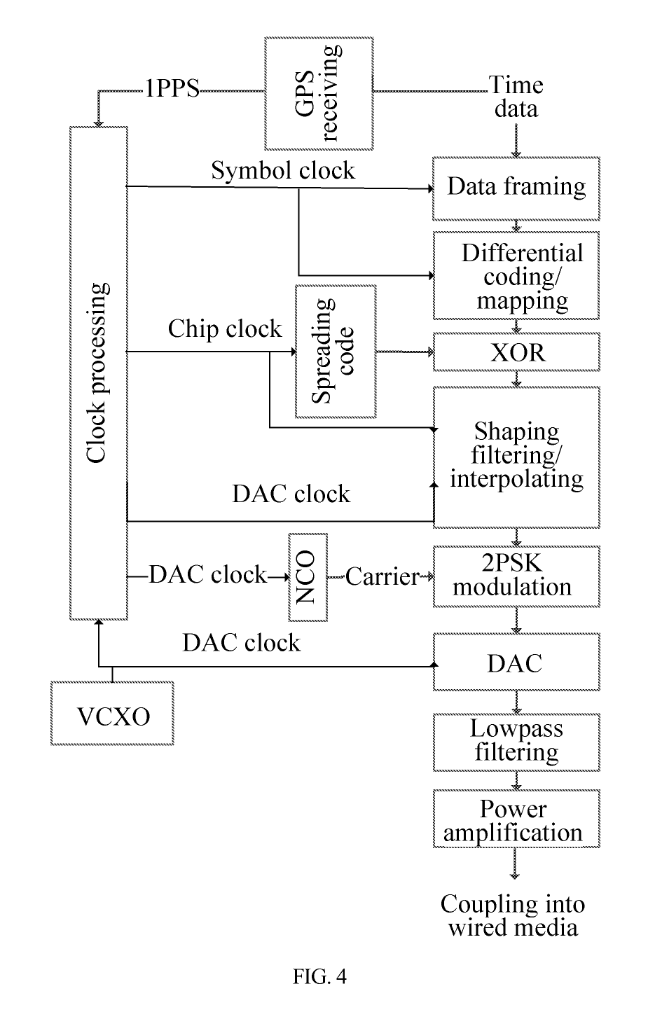

S203: As shown in FIG. 4, the clock data frame is spread through spreading codes (for example, direct sequence spreading), filtered (for example, through shaping filtering or interpolation filtering), and modulated (for example, through 2DPSK modulation), and then converted into an analog signal. For example, the clock data frame may be converted into an analog signal through digital up-converting and digital-to-analog converting. Further, the analog signal may undergo low-pass filtering and driving amplification, and may be coupled into the wired medium for broadcasting.

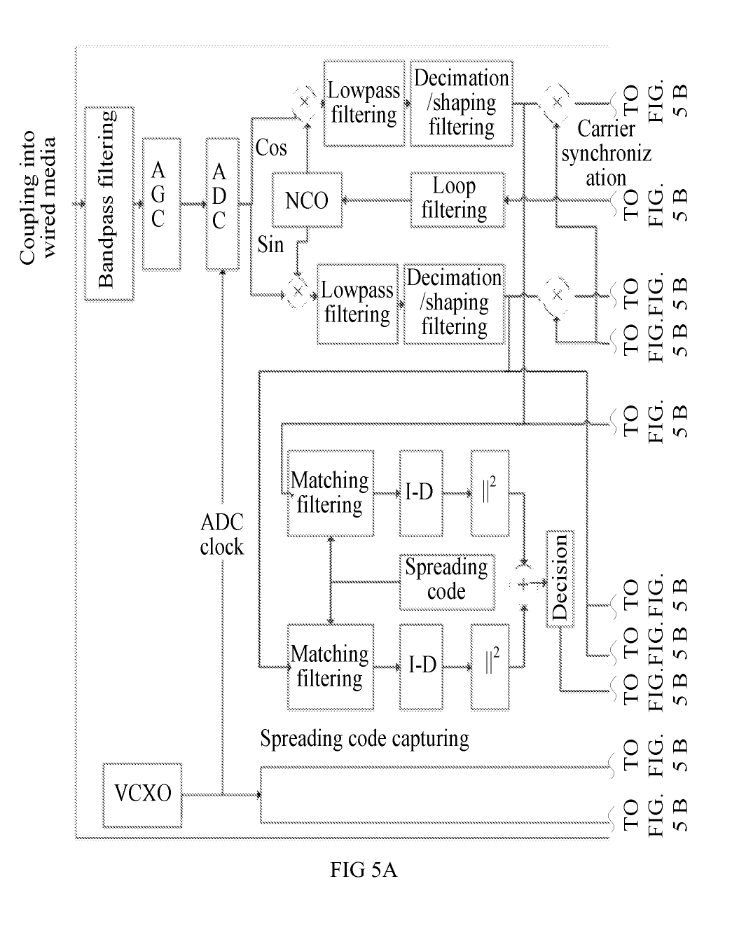

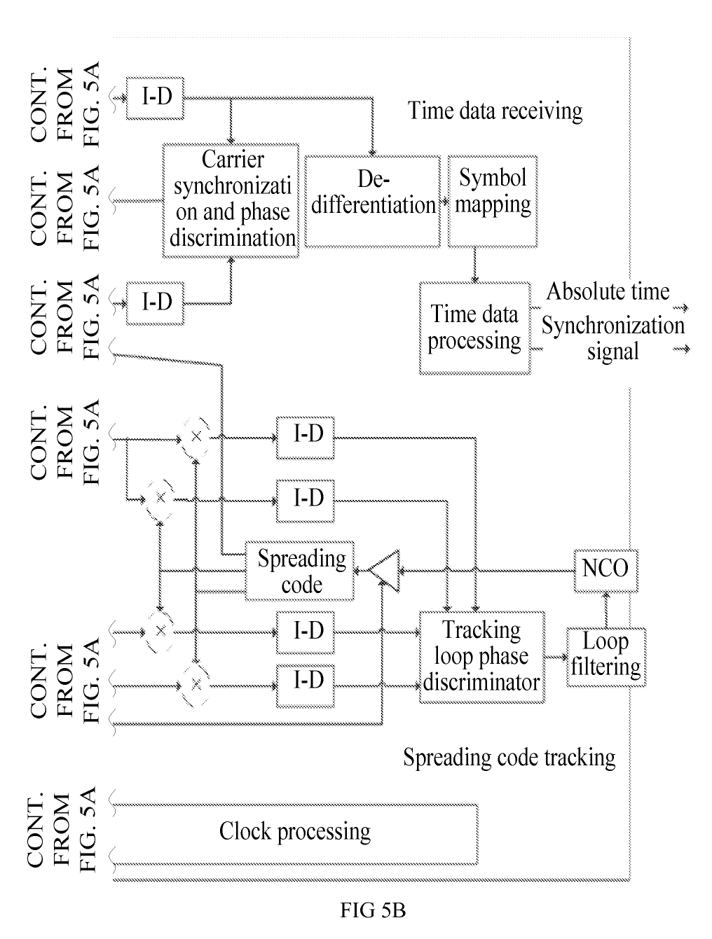

S204: As shown in FIG. 5A-5B, the CLK client receives the time synchronization signal broadcasted in the wired medium, and performs the converse of the foregoing operation for the time synchronization signal. For example, the CLK client performs bandpass filtering, AGC, ADC, digital down-converting, spreading code capturing and tracking, carrier synchronization and demodulation for the time synchronization signal to obtain a synchronization identifier. The synchronization identifier is processed to obtain the 1PPS and the absolute time information. Further, the synchronization clock of a higher frequency may be output for the phase-locked loop. The CLK client synchronizes time according to the 1PPS and the absolute time information.

In this embodiment, the base stations are connected through wired medium, the received time synchronization signal is coupled into the wired medium for broadcasting, and the time synchronization client obtains the time synchronization signal after receiving a broadcast signal. In this way, the time is synchronized between the base stations, and the μs-level time synchronization is accomplished between indoor base stations without extra cabling. Moreover, the time synchronization signal is spread through spreading codes to suppress the channel interference and attenuation of the wired network (especially complicated power cables) and ensure the synchronization precision.

### EMBODIMENT 3

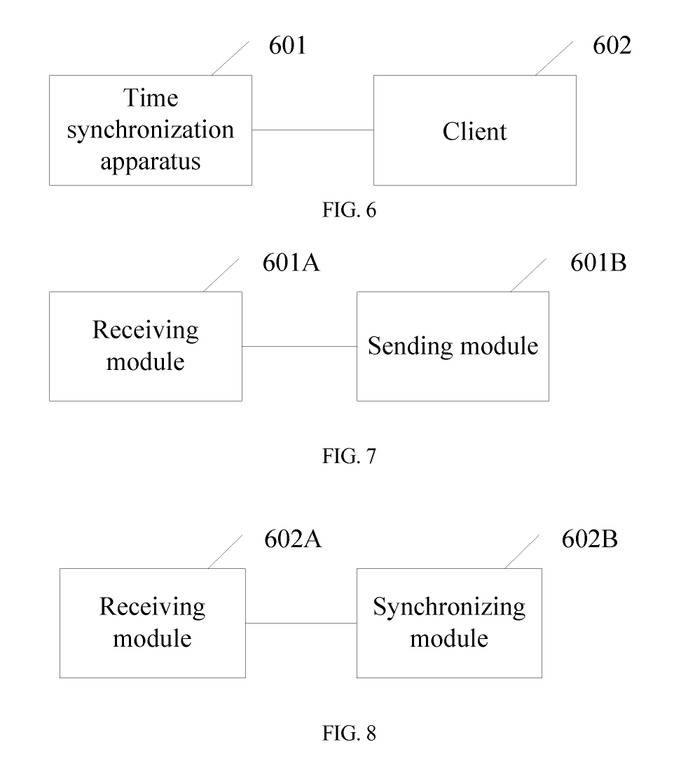

As shown in FIG. 6, a time synchronization system provided in this embodiment includes a time synchronization apparatus 601 and a client 602; wherein,

the time synchronization apparatus 601 is adapted to receive time synchronization signal which includes a 1PPS and an absolute time data, and send the time synchronization signal to a client 602 through a wired medium; and

the client 602 is adapted to receive the time synchronization signal, and synchronize time according to the time synchronization signal.

As shown in FIG. 7, the time synchronization apparatus 601 includes:

a receiving module 601A, adapted to receive a time synchronization signal which includes a 1PPS and an absolute time data; and

a sending module 601B, adapted to send the time synchronization signal to a client through a wired medium for synchronizing time.

The sending module 601B includes:

a coupling unit, adapted to couple the time synchronization signal into the wired medium; and

a broadcasting unit, adapted to broadcast the time synchronization signal in the wired medium.

The coupling unit may include:

a first processing unit, adapted to combine the 1PPS and the absolute time data into a clock data frame; and

a second processing unit, adapted to couple the clock data frame into the wired medium through spreading the clock data frame through spreading codes (for example, direct sequence spreading), filtering the clock data frame (for example, through shaping filtering or interpolation filtering), modulating the clock data frame (for example, through 2DPSK modulation), and then converting the clock data frame into an analog signal, for example, converting the clock data frame into an analog signal through digital up-converting and digital-to-analog converting; optionally, performing low-pass filtering and driving amplification for the analog signal, and couple the analog signal into the wired medium.

As shown in FIG. 8, the client 602 includes:

a receiving module 602A, adapted to receive the time synchronization signal broadcasted by the broadcasting unit of the time synchronization apparatus 601; and

a synchronizing module 602B, adapted to synchronize time according to the time synchronization signal received by the receiving module 602A.

The synchronizing module 602B may include:

a third processing unit, adapted to process the time synchronization signal to obtain a synchronization identifier, and more specifically, perform the converse of the operations performed by the second processing unit, for example, perform bandpass filtering, AGC, ADC, digital down-converting, spreading code capturing and tracking, and carrier synchronization and demodulation to obtain the synchronization identifier;

a fourth processing unit, adapted to process the synchronization identifier to obtain a 1PPS pulse and an absolute time information; and

a fifth processing unit, adapted to synchronize time according to the 1PPS and the absolute time data.

In this embodiment, the time synchronization apparatus and the clients make up a time synchronization system; the time synchronization apparatus is connected with the clients through an existing wired medium; the time synchronization apparatus couples the received time synchronization signal into the wired medium for broadcasting; and the client obtains the time synchronization signal after receiving a broadcast signal. In this way, the time is synchronized between the base stations, and the μs-level time synchronization is accomplished between indoor base stations without extra cabling. Moreover, the time synchronization signal is spread through spreading codes to suppress the channel interference and attenuation of the wired network (especially complicated power cables).

The embodiments of the present invention may be implemented through software or hardware. The software program may be stored in a readable storage medium such as a hard disk of the router, a buffer, or a Compact Disk (CD).

Although the invention has been described through some exemplary embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

What is claimed is:

1. A method for synchronizing time, comprising:
receiving a time synchronization signal which includes a 1PPS and an absolute time data; and
sending the time synchronization signal to a client through a wired medium for synchronizing time.

2. The method of claim 1, wherein the sending the time synchronization signal to a client through a wired medium for synchronizing time comprises:
coupling the time synchronization signal into the wired medium; and
broadcasting the time synchronization signal in the wired medium, in order to make the client synchronize time according to the received time synchronization signal.

3. The method of claim 2, wherein the time synchronization signal comprises a 1PPS and an absolute time data.

4. The method of claim 3, wherein the coupling the time synchronization signal into the wired medium comprises:
combining the 1PPS and the absolute time data into a clock data frame; and
coupling the clock data frame into the wired medium through spreading, filtering, modulating, digital up-converting, digital-analog conversion, low-pass filtering and driving amplification.

5. The method of claim 1, wherein the wired medium comprises: low-voltage power cable or coax cable or twisted pair.

6. An apparatus for synchronizing time, comprising:
a receiving module, adapted to receive a time synchronization signal which includes a 1PPS and an absolute time data; and
a sending module, adapted to send the time synchronization signal to a client through a wired medium for synchronizing time.

7. The apparatus of claim 6, wherein, the sending module comprises:
a coupling unit, adapted to couple the time synchronization signal into the wired medium; and
a broadcasting unit, adapted to broadcast the time synchronization signal in the wired medium.

8. The apparatus of claim 7, wherein, the coupling unit comprises:
a first processing unit, adapted to combine the 1PPS and the absolute time data into a clock data frame; and
a second processing unit, adapted to couple the clock data frame into the wired medium.

9. A method for synchronizing time, comprising:
receiving, by a client, a time synchronization signal through a wired medium; and
synchronizing, by the client, a time according to the received time synchronization signal.

10. The method of claim 9, wherein the time synchronization signal comprises a 1PPS and an absolute time data.

11. The method of claim 10, wherein the synchronizing, by the client, a time according to the received time synchronization signal comprises:
obtaining, by the client, a synchronization identifier through processing the time synchronization signal;
processing, by the client, the synchronization identifier to obtain the 1PPS and the absolute time data; and
synchronizing, by the client, the time according to the 1PPS and the absolute time data.

12. The method of claim 9, wherein the wired medium comprises: low-voltage power cable or coax cable or twisted pair.

13. A client for synchronizing time, comprising:
a receiving module, adapted to receive a time synchronization signal through a wired medium; and
a synchronizing module, adapted to synchronize time according to the time synchronization signal.

14. The client of claim 13, wherein the synchronizing module comprises:
a third processing unit, adapted to process the time synchronization signal to obtain a synchronization identifier;
a fourth processing unit, adapted to process the synchronization identifier to obtain a 1PPS and an absolute time information; and
a fifth processing unit, adapted to synchronize time according to the 1PPS and the absolute time data.
